(19) United States
(12) Patent Application Publication
(10) Pub. No.: US 2020/0210029 A1
(43) Pub. Date: Jul. 2, 2020

(54) RULE-BASED OPTIMIZATION OF OBJECT DISPLAYS ON USER INTERFACES

(71) Applicant: GOOGLE LLC, Mountain View, CA (US)

(72) Inventors: Dean Kenneth Jackson, Pittsburgh, PA (US); Daniel Victor Klein, Pittsburgh, PA (US)

(21) Appl. No.: 16/236,223

(22) Filed: Dec. 28, 2018

(51) Int. Cl. G06F 3/0482; G06F 9/451

(52) U.S. Cl. CPC G06F 3/0482; G06F 9/451

(57) ABSTRACT

A computing device receives a first display rule associated with an object category that defines whether unselected objects in the category are displayed when the object is selected, and a second display rule associated with an object that defines whether the object can continue to be displayed when the object is selected. The computing device renders a first display of the listing on a user interface of another computing device. The computing device receives notification of selection of a user interface element on the second computing device requesting selection of the object from the first display and analyzes the object by determining the object category, the first display rule, and the second display rule. The computing devices render a second display of the listing on a user interface of the second computing device comprising an updated display of the objects according to the first and second display rules.

### TECHNICAL FIELD

The technology disclosed herein relates to optimizing presentation of objects on a user interface.

### BACKGROUND

Users often create lists that comprise a listing of objects. In a conventional system, selection of one object from a display of the objects results in removal of the selected object from the display rendered on the user interface. Additionally, conventional systems return a display of multiple non-selected objects without reference to the user's preference or intent when entering the selected object on the original listing of objects. Without mapping the user's intent each of the multiple objects, the user is presented with a non-optimized listing of multiple objects.

### SUMMARY

In certain example aspects described herein, a method to optimize object presentation on graphical user interfaces, comprises one or more computing devices receiving a notification of selection of a user interface element on a first computing device requesting selection of an object and creation of an object category to associate the selected object in a listing on an electronic document of available objects. The one or more computing devices receiving a first display rule associated with the object category, wherein the first display rule defines whether unselected objects in the object category can be displayed in the listing when the selected object is selected, and receiving a second display rule associated with the selected object, wherein second display rule defines whether the selected object can continue to be displayed when the selected object is selected. The one or more computing device receiving a second notification of selection of a second user interface element on a second computing device requesting a display of objects in the listing and rendering a first display of the listing on a user interface of the second computing device, the first display comprising at least the selected object and one or more unselected objects. The one or more computing devices receiving a third notification of selection of a third user interface element on the second computing device requesting selection of the selected object from the first display and analyzing the selected object by: determining that the selected object was placed in the object category, determining the first display rule associated with the object category that defines whether the one or more unselected object in the object category can be displayed when the selected object is selected, and determining the second display rule associated with the selected object that defines whether the selected object can continue to be displayed when the selected object is selected. The one or more computing devices rendering a second display of the listing on a user interface of the second computing device, the second display comprising an updated display of the two or more objects in the listing according to the determined first display rule associated with the display of the one or more unselected object and the determined second display rule associated with the display of the selected object.

In certain other example aspects described herein, systems and computer program products to optimize object display on a user interface are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting system to optimize object presentation, in accordance with certain example embodiments.

FIG. 2 is a block flow diagram depicting a method to create a categorized object list, in accordance with certain example embodiments.

FIG. 3 is a block flow diagram depicting a method to select an object to add to the object list, in accordance with certain example embodiments.

FIG. 4 is a block flow diagram depicting a method to create display categories, in accordance with certain example embodiments.

FIG. 5 is a block flow diagram depicting a method to select an object from the display of objects, in accordance with certain example embodiments.

FIG. 6 is a block diagram depicting a computing machine and module, in accordance with certain example embodiments.

### DETAILED DESCRIPTION OF THE EXAMPLE EMBODIMENTS

### Overview

The example embodiments described herein provide computer-implemented techniques for creating categorized wish lists. In an example embodiment, a wisher registers with an account management system and enables an application or function on the wisher device. In an example embodiment, the application comprises a retail, shopping, or wish list function that enables the wisher to select items that the wisher desires and place the items on a wish list for purchaser by a purchaser. The wisher enters search attributes for a desired item. The application performs a search of current items and returns a list of items that match or are related to the search attributes. In an example embodiment, the wisher can refine the search attributes until the wisher finds a desired item. In another example embodiment, the wisher enters a URL or web address for a desired product. In yet another example embodiment, the user clicks a link or button and is directed to a desired product. In an example embodiment, the wisher can access additional information about each item returned in the search results.

Once the wisher finds the desired item, the wisher indicates a desire to add the item to a wish list and the application prompts the wisher to create a new wish list category. In an example embodiment, each wish list category comprises one or more defined rules that determine how the remaining items in the wish list are handled once an item is selected by a purchaser. In an example embodiment, the wish list category rules are defined or selected by the wisher when the category is created. For example, the wisher may only desire one item in the wish list category. In this example, once one of the items is selected, the remaining items are not available for selection by a second purchaser. In another example, the wisher may desire more than one item in the wish list category. In this example, the remaining items remain available once one item is selected by a purchaser. In yet another example, the wisher may desire a specific number of items in the category.

In another example embodiment, the wish list category rules are specific to a particular item added to the wish list category. In this embodiment, the category rules are defined or selected by the wisher when the item is added to the wish list category. For example, the wisher may desire more than one of an item. In this example, the selected item remains on the wish list once it is selected by a purchaser. In another example, the wisher may desire more than one item in a wish list category, so long as it is not the same item. In this example, once the item is selected, it is no longer available for selection by a second purchaser. In an example embodiment, the application prompts the user to select or define the rules for the category and for the item added to the category.

After the item is added to a category on the wisher's wish list, a purchaser accesses the wish list application and the wisher's wish list. In an example embodiment, the purchaser can be the wisher or a different party that desires to purchase an item for the wisher. The purchaser selects an item from the wisher's wish list. In an example embodiment, the purchaser selects the item by indicating a desire to place the item in the purchaser's electronic shopping cart or a desire to purchase the item. The application receives a notification that the purchaser selected the item from the wisher's wish list and retrieves the rules associated with the wish list category and the selected item. The application applies the rules to determine whether the other items in the wish list category remain available for selection and whether the selected item remains available for selection. If the purchaser does not complete the purchase of the selected item, the application marks the selected item and the remaining items in the wish list category as again available for selection.

Various example embodiments will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

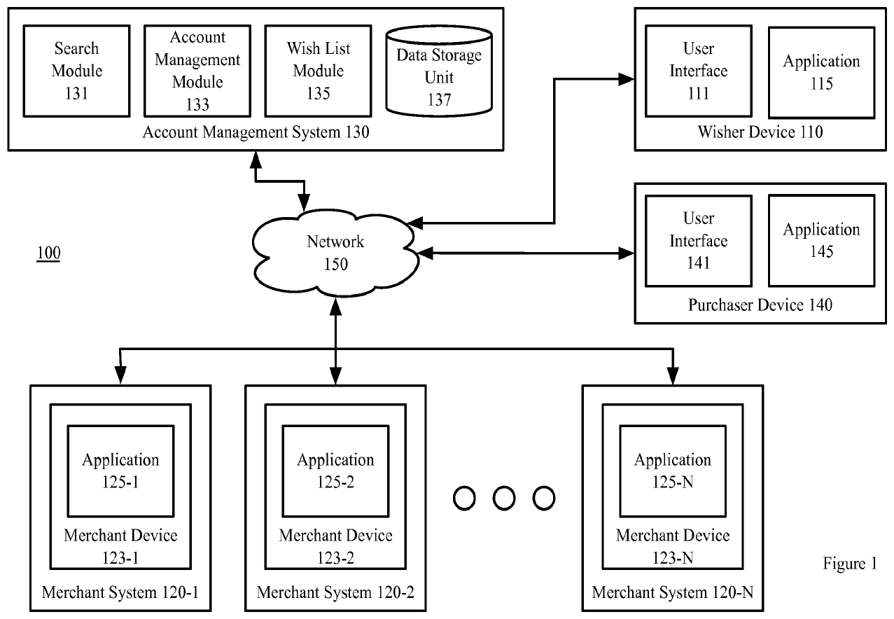

FIG. 1 is a block diagram depicting a wish list system 100, in accordance with certain example embodiments. As depicted in FIG. 1, the exemplary operating environment 100 comprises a wisher computing device 110, one or more merchant computing systems 120, an account management computing system 130, and a purchaser computing device 140 that are configured to communicate with one another via one or more networks 150. In another example embodiment, two or more of these computing systems (including systems 110, 120, 130, and 140) are integrated into the same system. In some embodiments, a user associated with a device must install an application and/or make a feature selection to obtain the benefits of the techniques described herein.

Each network 150 includes a wired or wireless telecommunication means by which network systems (including systems 110, 120, 130, and 140) can communicate and exchange data. For example, each network 150 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, Bluetooth Low Energy (BLE), near field communication network (NFC), any form of standardized radio frequency, infrared, sound (for example, audible sounds, melodies, and ultrasound), other short range communication channel, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In an example embodiment, each network computing system (including systems 110, 120, 130, and 140) includes a device having a communication module capable of transmitting and receiving data over the network 150. For example, each network system (including systems 110, 120, 130, and 140) may comprise a server, personal computer, mobile device (for example, notebook computer, tablet computer, netbook computer, personal digital assistant (PDA), video game device, GPS locator device, cellular telephone, Smartphone, or other mobile device), a television with one or more processors embedded therein and/or coupled thereto, or other appropriate technology that includes or is coupled to a web browser or other application for communicating via the network 150. In the example embodiment depicted in FIG. 1, the network systems (including systems 110, 120, 130, and 140) are operated by wishers, merchants, an account management system operator, and purchasers, respectively.

In an example embodiment, the wisher device 110 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that includes or is coupled to a web server, or other suitable application for interacting with web page files. The wisher can use the wisher device 110 to browse items, create a wish list and/or a wish list category, and add one or more items to the wish list and/or wish list category via a user interface 111 and an application 115. The application 115 is a program, function, routine, applet or similar entity that exists on and performs its operations on the wisher device 110. For example, the application 115 may be one or more of a shopping application, merchant system 120 application, an Internet browser, a digital wallet application, a loyalty card application, another value-added application, a user interface 111 application, or other suitable application operating on the wisher device 110. In some embodiments, the wisher must install an application 115 and/or make a feature selection on the wisher device 110 to obtain the benefits of the techniques described herein.

An example wisher device 110 communicates with the account management system 130. An example account management system 130 comprises an account management module 133 that maintains an account for the wisher. In an example embodiment, the account management system 130 further comprises a wish list module 135 that maintains a wish list with one or more categories with items the wisher has selected. In an example embodiment, the wisher browses for the one or more items using the search module 131 and indicates a desire to place the items on a wish list maintained by the wish list module 135. In another example embodiment, the function of one or more of the modules (including 131, 133, and 135) are combined.

In an example embodiment, the account management system 130 maintains a listing of items available for purchase. In an example embodiment, the products are sold by one or more different merchant systems 120-N. In another example embodiment, the items are sold by the account management system 130. A listing of the available products is saved in the data storage unit 137. In an example embodiment, the data storage unit 137 can include any local or remote data storage structure accessible to the account management system 130 suitable for storing information. In an example embodiment, the data storage unit 137 stores encrypted information.

Each merchant system 120-N comprises at least one merchant device 123-N that is capable of communicating with the account management system 130 via an application 125-N. In an example embodiment, the merchant system 120-N transmits information for one or more items available for purchase to the account management system 130. The wisher is able to access at least part of the product information via the search module 131 when determining which items to add to the wisher's wish list.

In an example embodiment, a purchaser is able to access the wisher's wish list to select and/or purchase one or more products from the wish list. In an example embodiment, the purchaser device 140 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that includes or is coupled to a web server, or other suitable application for interacting with web page files. The purchaser can use the purchaser device 140 to access the wisher's wish list and select one or more products from the wish list category via a user interface 141 and an application 145. The application 145 is a program, function, routine, applet or similar entity that exists on and performs its operations on the purchaser device 140. For example, the application 145 may be one or more of a shopping application, merchant system 120 application, an Internet browser, a digital wallet application, a loyalty card application, another value-added application, a user interface 141 application, or other suitable application operating on the purchaser device 140. In some embodiments, the purchaser must install an application 145 and/or make a feature selection on the purchaser device 140 to obtain the benefits of the techniques described herein.

In an example embodiment, the account management system 130 and/or merchant device 123-N is capable of processing a purchase transaction initiated by the purchaser. In an example embodiment, the merchant operates an online store and the purchaser indicates a desire to make a purchase by clicking a link or “checkout” button on a website. In another example embodiment, the account management system 130 completes the purchase and performs a settlement operation with the merchant system 120-N. In yet another example embodiment, the account management system 130 comprises the merchant system 120-N that operates an online store.

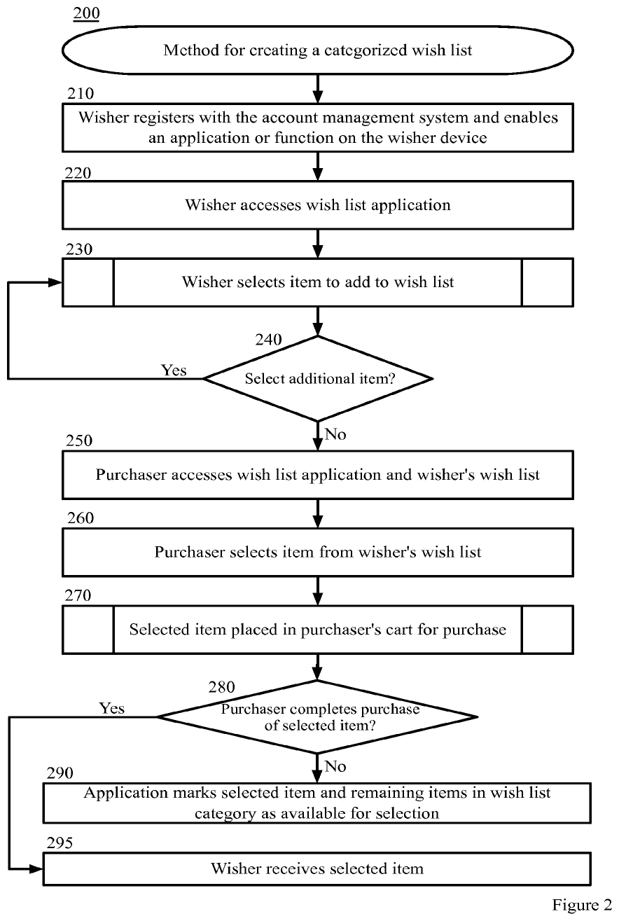

The components of the example operating environment 100 are described hereinafter with reference to the example methods illustrated in FIGS. 2-5. The example methods of FIGS. 2-5 may also be performed with other systems and in other environments.

### Example System Processes

FIG. 2 is a block flow diagram depicting a method 200 for creating a categorized wish list, in accordance with certain example embodiments. The method 200 is described with reference to the components illustrated in FIG. 1.

In block 210, the wisher registers with the account management system 130. In an example embodiment, the wisher installs, downloads, or otherwise enables an account management system 130 program, feature, or application 115 on the wisher device 110. In an example embodiment, the account management system 130 application 115 comprises a digital wallet application 115. In an example embodiment, the wisher enables the application 115 on more than one wisher device 110.

In an example embodiment, the wisher is prompted to log into, has previously logged into, or is otherwise automatically logged into the account management system 130. In another example embodiment, the wisher's login credentials are shared across other accounts (for example, social networking websites and wisher device 110 accounts), and the wisher is automatically logged into the account management system 130 account using the shared login credentials. If the wisher does not have an account management system 130 account, the wisher is typically prompted to create an account management system 130 account. In an example embodiment, the wisher may create the account management system 130 account at any time prior to saving an item to a wish list. In an example embodiment, the wisher accesses the account management system 130 via a website or application 115. In an example embodiment, the wisher submits registration information to the account management system 130, including, but not limited to, name, address, phone number, e-mail address, and/or information for one or more registered financial accounts, including bank account debit cards, credit cards, a loyalty rewards account card, or other type of account that can be used to make a purchase (for example, card type, card number, expiration date, security code, and billing address). In an example embodiment, the wisher's account management system 130 account information is saved in the data storage unit 137 and is accessible to the account management module 133 and wish list module 135. In an example embodiment, the account management system 130 account is a digital wallet account maintained by the account management system 130 or a third party system.

In block 220, the wisher accesses a wish list application 115. In an example embodiment, the wish list application 115 comprises an application 115 maintained by the account management system 130 that enables the wisher to browse and/or search for items for sale. In an example embodiment, the wish list application 115 enables the wisher to select one or more items and add the selected items to a wish list. An example wish list comprises one or more categories or sub-wish lists defined by one or more rules. An example rule determines the availability of the remaining items in the wish list category when one item is selected by a purchaser. For example, the remaining items become unavailable for selection when one item is selected; or else the remaining items remain available for selection. Another example rule determines the availability of the selected item when it is selected by the purchaser. For example, the product remains available after it is selected until it is purchased a pre-determined number of times; or else the product is no longer available for selection by another purchaser once it is selected. In another example embodiment, a rule determines the availability of a specific item or set of items in the wish list category when one item is selected. For example, if one item is selected, then another predetermined item is no longer available for selection. In an example embodiment, the one or more rules are defined by the wisher and/or account management system 130 when the item is selected, the wisher adds the item to the wish list category, and/or the wish list category is created.

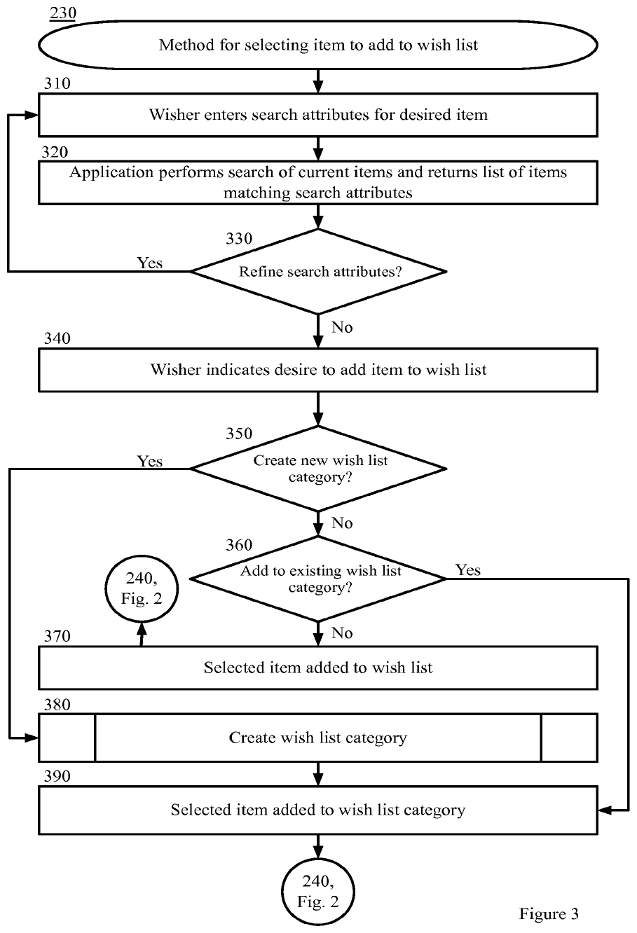

In block 230, the wisher selects an item to add to a wish list. The method for selecting an item to add to the wish list is described in more detail hereinafter with reference to the methods described in FIG. 3.

FIG. 3 is a block flow diagram depicting a method 230 for selecting an item to add to the wish list, in accordance with certain example embodiments, as referenced in block 230. The method 230 is described with reference to the components illustrated in FIG. 1.

In block 310, the wisher enters search attributes for a desired item. In an example embodiment, the search attributes comprise one or more keywords or search terms that describe the desired item. In an example embodiment, each product available for purchase or selection comprises one or more product attribute. In an example embodiment, the product attributes are defined by the merchant system 120-N, the account management system 130, and/or a third party system (for example, a product manufacturer). In another example embodiment, the wisher enters a URL or web address for a product. In yet another example embodiment, the user clicks a link or button and is directed to a product. In yet another example embodiment, the user clicks on an advertisement, offer, or other display and is directed to a product.

In block 320, the application performs a search of current items available for purchase and returns a list of items. In an example embodiment, the account management system 130 compares the search attributes to the product attributes and returns one or more products with product attributes that are similar to the search attributes. In an example embodiment, the wisher and/or purchaser can select an item from the returned list of items to view additional product information. In an example embodiment, the wisher can select an item from the returned list and indicate a desire to add the product to a wish list and/or wish list category.

In block 330, the wisher determines whether the search attributes need to be refined. For example, the wisher determines whether the returned list comprises one or more items the wisher desires to add to a wish list.

If the wisher needs to refine the search attributes, the method 230 returns to block 310 in FIG. 3 and the wisher enters the refined search attributes. In an example embodiment, the refined search attributes comprise different search attributes than the wisher originally entered. In another example embodiment, the wisher is attempting to narrow down the returned list and the refined search attributes comprise additional search attributes. For example, the wisher enters additional information about the desired item so that fewer products match the search attributes.

In an example embodiment, the wisher repeats the methods described in block 310 through 330 until the returned list comprises one or more items the wisher desires to add to a wish list.

Returning to block 330 in FIG. 3, if the returned list comprises one or more items the wisher desires to add to a wish list, the method 230 proceeds to block 340 in FIG. 3.

In block 340, the wisher indicates a desire to add an item to a wish list. In an example embodiment, the wisher selects the items and clicks a button or makes a selection that indicates a desire to add the item to the wish list. In another example embodiment, the wisher clicks on or highlights the item and drags it to a wish list. In an example embodiment, the wisher is logged into the account management system 130. In another example embodiment, the wisher is not logged into the account management system 130 and is prompted to log into the account when indicating the desire to add the item to a wish list. In another example embodiment, the wisher indicates a desire to add a URL or web address associated with the desired product to the wish list. In this embodiment, the user access the wish list and indicates a desire to add a URL of the desired product. In another example embodiment, the user indicates a desire to add an image or link that directs a potential purchaser to the desired product.

In block 350, the wisher is prompted to determine whether the wisher desires to create a new category in the wish list. In an example embodiment, the wisher is prompted in response to indicating the desire to add the item to the wish list. For example, a pop-up window, screen, or box with an option to crate a new wish list category is presented. In another example embodiment, the wisher indicates a desire to create a new category when selecting the item to add to the wish list. For example, the wisher selects a button or activates a feature when indicating a desire to place the item on the wish list.

If the wisher does not indicate a desire to create a new wish list category, the method 230 proceeds to block 360 in FIG. 3.

In block 360, the wisher is prompted to determine whether the wisher desires to add the item to an existing wish list category. In an example embodiment, the wisher is prompted in response to declining to create a new wish list category or in response to indicating the desire to add the item to the wish list. For example, a pop-up window, screen, or box with an option to create a new wish list category is presented. In another example embodiment, the wisher indicates a desire to add the item to an existing category when selecting the item to add to the wish list. For example, the wisher selects a button or activates a feature when indicating a desire to place the item on the wish list.

If the wisher does not indicate a desire to add the item to an existing wish list category, the method 230 proceeds to block 370 in FIG. 3. In block 370, the selected item is added to the wisher's wish list.

In an example embodiment, the wisher may create, modify, and delete wish list categories at any time. For example, the wisher may create wish list categories prior to identifying the desired product or after the desired product was identified and added to the wish list. In this example, the wisher may define the rules associated with the previously-created wish list category at the time the wish list category is created, when adding the desired product to the wish list category, or at any time prior to or after adding the desired product. In an example embodiment, the wisher may create, modify, and delete subcategories within a wish list category at any time.

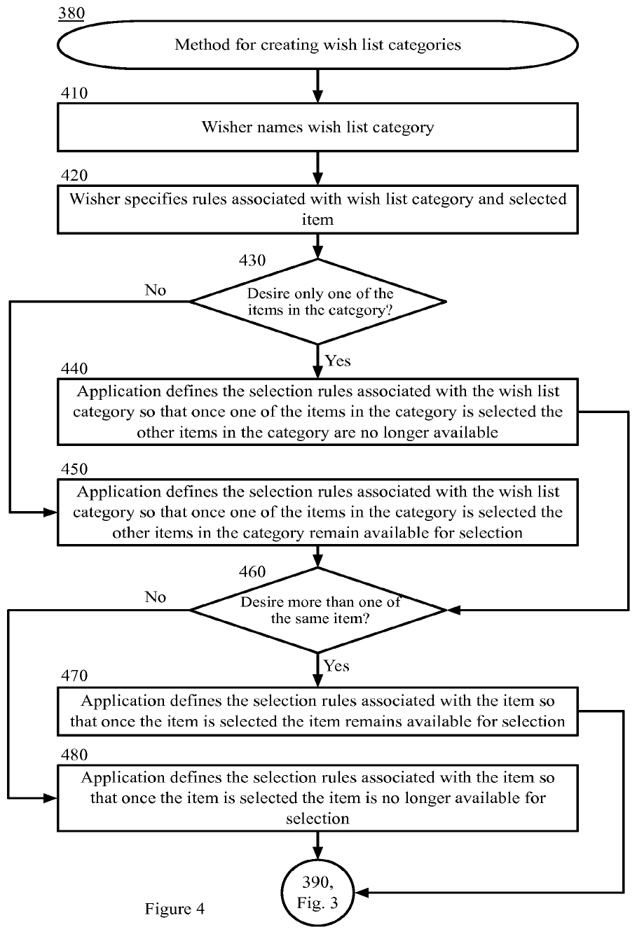

Returning to block 360 in FIG. 3, if the wisher indicates a desire to add the item to an existing category, the method 230 proceeds to block 390 in FIG. 3. In block 390, the selected item is added to the wish list category. In an example embodiment, the wish list category was previously created by the wisher and comprises one or more previously-defined rules. In an example embodiment, the wish may refine, define, or remove one or more rules at any time. Defining and adding one or more rules is discussed in further detail hereinafter with reference to the methods described in FIG. 4.

Returning to block 350 in FIG. 3, if the wisher indicates a desire to crate a new wish list category, the method 230 proceeds to block 380 in FIG. 3. In block 380, the wisher creates a new wish list category. The method for creating wish list categories is described in more detail hereinafter with reference to the methods described in FIG. 4.

FIG. 4 is a block flow diagram depicting a method 380 for creating wish list categories, in accordance with certain example embodiments, as referenced in block 380. The method 380 is described with reference to the components illustrated in FIG. 1.

In block 410, the wisher names the wish list category. In an example embodiment, the wisher enters or selects a name for the wish list category by typing, keying or clicking on a name when prompted by the application 115. In another example embodiment, the wish list category is named by the application.

In block 420, the wisher specifies one or more rules associated with the wish list category and the selected item. In an example embodiment, the wisher is prompted with available rules by the application 115 and the wisher selects the rules to apply to the wish list category and/or selected item. In an example embodiment, different items in the category may have different rules associated with each item. In this embodiment, the wisher may be prompted to select a rule for each item when indicating a desire to add the item to the wish list category. In another example embodiment, the rules that are selected for the wish list category apply to each item in or added to the wish list category. In another example embodiment, the wisher can add, modify, and delete rules associated with each item on the wish list or the wish list category at any time.

In block 430, the wisher determines whether the wisher desires only one of the items in the category. For example, the wisher may desire only one of multiple wallets added to the wish list category.

If the wisher desires only one of the items in the wish list category, the method 380 proceeds to block 440 in FIG. 4. In block 440, the application defines the selection rules associated with the wish list category so that once one of the items in the category is selected, the other items in the category are no longer available for selection. Continuing with the previous example, once one of the wallets in the wish list category is selected, the other wallets are no longer available, thus preventing the wisher from receiving multiple wallets.

From block 440, the method 380 proceeds to block 460 in FIG. 4.

Returning to block 430 in FIG. 4, if the wisher desires more than one of the items in the category, the method 380 proceeds to block 450 in FIG. 4. In block 450, the application defines the selection rules associated with the wish list category so that once one of the items in the category is selected, the other items in the category remain available for selection. In an example embodiment, the wisher can define a number of items in the category that is desired. For example, the wisher desires three shirts in the wish list category. Once the first shirt is selected, the remaining shirts remain available for selection. However, once the third shirt is selected, the remaining shirts are no longer available for selection.

From block 450, the method 380 proceeds to block 460 in FIG. 4. In block 260, the wisher determines whether the wisher desires more than one of the same item in the wish list category. In an example embodiment, the wisher defines this rule for each item that is added to the wish list category. For example, the wisher may desire more than one of a specific bowl added to the wish list category.

If the wisher desires more than one of the specific item in the wish list category, the method 380 proceeds to block 470 in FIG. 4. In block 470, the application defines the selection rules associated with the specific item so that once the item is selected, the item remains available for selection. Continuing with the previous example, once the specific bowl is selected, it remains available in the wish list category for selection. In another example embodiment, the wisher can define a number of the specific item that is desired. For example, the wisher desires six of the bowls. Once the first bowl is selected, the bowl remains available for selection. However, once the bowl is selected for the sixth time, the bowl is no longer available for selection.

From block 470, the method 380 proceeds to block 390 in FIG. 3.

Returning to block 460 in FIG. 4, if the wisher desires only one of the specific item in the wish list category, the method 380 proceeds to block 470 in FIG. 4. In block 440, the application defines the selection rules associated with the selected item so that once the item is selected, the item is not longer available for selection. For example, once the bowl is selected, it is no longer available, thus preventing the wisher from receiving more than one of the same bowl.

In an example embodiment, the rules for the wish list category and each item are applied together. For example, the wisher added multiple different shirts to the wish list category. However, the wisher desires three of the same shirt from the wish list category. In this example, the selection rule associated with the category would remove the remaining shirts once the first shirt is selected and the selection rule associated with the item would leave the shirt available for selection two more times so that the wisher can receive three of the same shirt.

In another example, the wisher added multiple different dresses to the wish list category. The wisher desires two dresses. However the wisher does not desire two of the same dress. In this example, the selection rule associated with the category would leave the remaining dresses once the first dress was selected and the selection rule associated with the first dress would remove the first dress from the wish list category once it was selected so the wisher did not receive two of the same dress. Once the second dress was selected, the selection rule associated with the wish list category would remove all the remaining dresses so the wisher only received two dresses.

The method 380 then proceeds to block 390 in FIG. 3.

Returning to FIG. 3, in block 390, the selected item is added to the wish list category, for example, by associating the item with a record for the wish list in a database.

The method 230 then proceeds to block 240 in FIG. 2.

Returning to FIG. 2, in block 240, the wisher determines whether to add additional items to the wish list. In an example embodiment, the wisher may add or remove items from the wish list and the wish list categories at any time.

If the wisher adds an additional item to the wish list, the method 200 proceeds to block 230. In an example embodiment, the methods described in blocks 230 and 240 are repeated until the wisher has added the desired items to the wish list. In another example embodiment, the methods described in blocks 230 and 240 are repeated until the purchaser accesses the wisher's wish list and selects an item.

Returning to block 240, if the wisher does not select additional items to add to the wish list, the method 200 proceeds to block 250 in FIG. 2. In an example embodiment, the wish list is available for access by the purchaser once it is created. In another example embodiment, the wisher indicates a desire to make the wish list available (for example, by selecting an option or enabling a feature).

In block 250, the purchaser accesses a wish list application 145. In an example embodiment, the wish list application 145 comprises an application 145 maintained by the account management system 130 that enables the purchaser to browse items selected by the wisher to be added to the wisher's wish list. In an example embodiment, the purchaser searches for the wisher's wish list and/or wish list categories. In an example embodiment, the wish list application 145 returns a list of the wisher's wish list categories and allows the purchaser to select and view the items in the wisher's selected wish list category.

For example, the purchaser searches for the wisher, and the application 145 returns a listing of different wishers. The purchaser selects the correct wisher, and the application returns a list of the wisher's different wish lists and/or wish list categories. The purchaser selects the desired wish list category, and the items saved by the wisher in the wish list category are displayed.

In block 260, the purchaser selects an item from the displayed wish list category. In an example embodiment, the purchaser can view additional information about the selected item and indicate a desire to place the item in the purchaser's electronic shopping cart. For example, the purchaser presses a button or other control or enables a feature that indicates a desire to purchase the selected item. In an example embodiment, the purchaser can complete a checkout process to pay for and purchase the selected item.

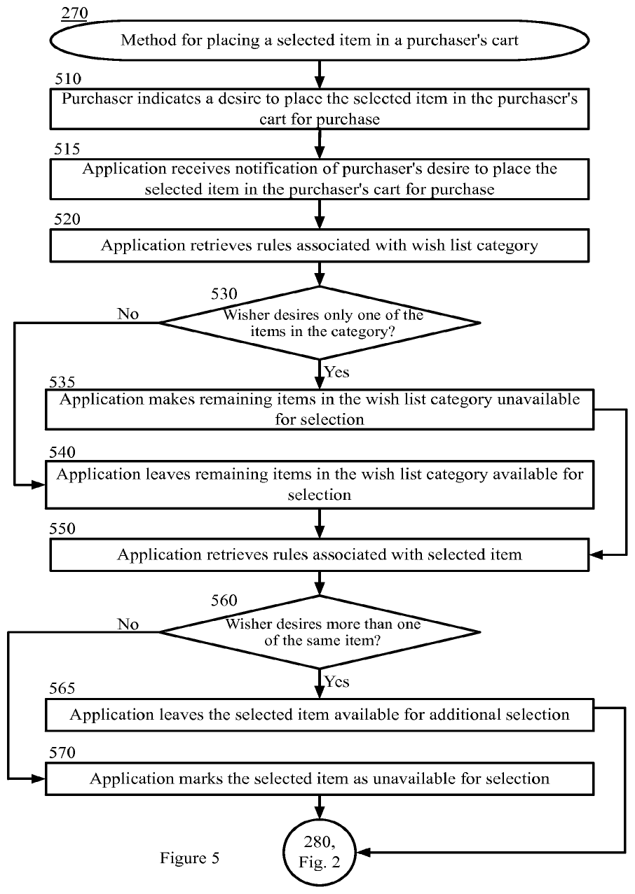

In block 270, the selected item is placed in the purchaser's electronic shopping cart. The method 270 for placing a selected item in a purchaser's cart is described in more detail hereinafter with reference to the methods described in FIG. 5.

FIG. 5 is a block flow diagram depicting a method 270 for placing a selected item in a purchaser's cart, in accordance with certain example embodiments, as referenced in block 270. The method 270 is described with reference to the components illustrated in FIG. 1.

In block 510, the purchaser indicates a desire to place the selected item in the purchaser's electronic shopping cart for purchase. In an example embodiment, the purchaser presses a button or enables a feature to indicate a desire to place the selected item in the electronic shopping cart.

In block 515, the application 145 receives a notification that the purchaser desires to place the selected item in the purchaser's electronic shopping cart. In an example embodiment, the application places the item in the electronic shopping cart and enables the purchaser to complete the purchase of the selected item.

In block 520, the application 145 retrieves the rules associated with the wish list category. In an example embodiment, the application 145 communicates with the account management system 130 to retrieve the rules.

In block 530, the application 145 determines whether the wisher desires only one of the items in the wish list category. In an example embodiment, the application 145 reviews the retrieved rules to make the determination. In an example embodiment, the rules are understandable by the application 145 and the account management system 130 without human intervention.

If the wisher desires only one of the items in the wish list category, the method 270 proceeds to block 535 in FIG. 5. In another example embodiment, the wisher desires a predetermined number of items N in the wish list category and N−1 number of items have been previously selected. For example, the wisher desires five items from the wish list category and four items have been previously selected. Accordingly, only one additional item is desired. In block 535, the application 145 makes the remaining items in the wish list category unavailable for selection. In another example embodiment, the application 145 makes the selected item grayed out or indicates that the selected item has been selected by another purchaser. In another example embodiment, the application 145 communicates with the account management system 130 and the account management system 130 makes the remaining items in the wish list category unavailable for selection. In an example embodiment, the remaining items are unavailable for selection by the purchaser who selected the item and any other purchaser who accesses the wisher's wish list. In yet another example embodiment, the selected item is available for selection by the purchaser who selected the item and any other purchaser who accesses the wisher's wish list until the purchaser completes the purchase of the selected item.

The method 270 then proceeds to block 550 in FIG. 5.

Returning to block 530 in FIG. 5, if the wisher desires more than one of the items in the category, the method 270 proceeds to block 540 in FIG. 5. In an example embodiment, the wisher desires two or more items in the wish list category. In block 540, the application 145 leaves remaining items in the wish list category available for selection. In an example embodiment, the remaining items are available for selection by the purchaser who selected the item and any other purchaser who accesses the wisher's wish list.

In block 550, the application 145 retrieves the rules associated with the selected item. In an example embodiment, the application 145 communicates with the account management system 130 to retrieve the rules.

In block 560, the application 145 determines whether the wisher desires more than one of the same selected item. In an example embodiment, the application 145 reviews the retrieved rules to make the determination. In an example embodiment, the rules are understandable by the application 145 and the account management system 130 without human intervention.

If the wisher desires more than one of the same selected item, the method 270 proceeds to block 565 in FIG. 5. In an example embodiment, the wisher desires two or more of the selected item. In block 565, the application 145 leaves the selected item in the wish list category for selection. In an example embodiment, the selected item is available for selection by the purchaser who selected the item and any other purchaser who accesses the wisher's wish list.

The method 270 then proceeds to block 280 in FIG. 2.

Returning to block 560 in FIG. 5, if the wisher does not desire more than one of the same selected item, the method 270 proceeds to block 570 in FIG. 5. In another example embodiment, the wisher desires a predetermined number of a selected item N in the wish list category and N−1 number of the selected item have been previously selected. For example, the wisher desires three of the selected items and two items have been previously selected. Accordingly, only one more of the selected item is desired. In block 570, the application 145 makes the selected item in the wish list category unavailable for selection. In another example embodiment, the application 145 makes the selected item grayed out or indicates that the selected item has been selected by another purchaser. In another example embodiment, the application 145 communicates with the account management system 130 and the account management system 130 makes the selected item in the wish list category unavailable for selection. In an example embodiment, the selected item is unavailable for selection by the purchaser who selected the item and any other purchaser who accesses the wisher's wish list. In yet another example embodiment, the selected item is available for selection by the purchaser who selected the item and any other purchaser who accesses the wisher's wish list until the purchaser completes the purchase of the selected item.

The method 270 then proceeds to block 280 in FIG. 2.

Returning to FIG. 2, in block 280, the purchaser determines whether the complete the checkout process and purchase the selected item. In an example embodiment, the purchaser provides payment account information or authorization to complete a financial transaction to purchase the selected item.

If the purchaser completes the purchase of the selected item, the method 200 proceeds to block 295 in FIG. 2. In block 295, the purchased item is sent or mailed to the wisher. In another example embodiment, the purchased product is made available to the wisher or a party designated by the wisher.

Returning to block 280 in FIG. 2, if the purchaser does not complete the purchase of the selected item, the method 200 proceeds to block 290 in FIG. 2. In block 290, the application 145 marks the selected item and the remaining items in the wish list category as available for selection by a purchaser. In an example embodiment, selected items in a purchaser's electronic shopping cart comprise a time limit or rule that defines an amount of time the item will remain in the purchaser's electronic shopping cart before returning to the wish list.

### Other Example Embodiments

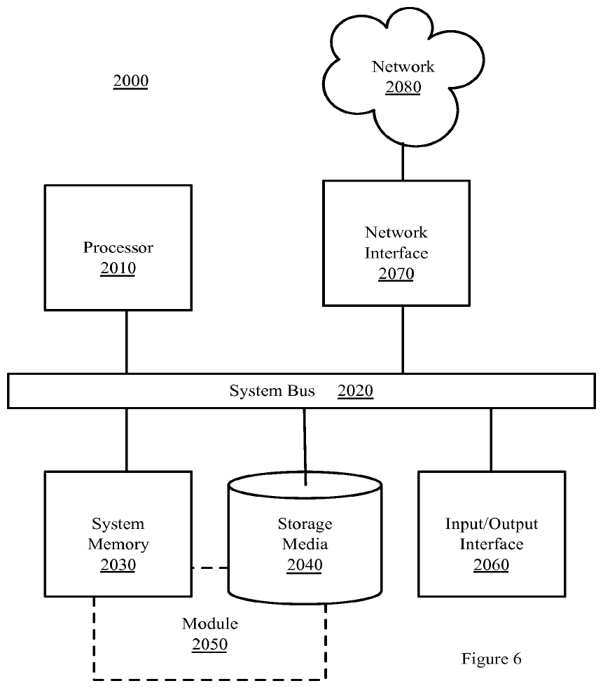

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to optimize object presentation on graphical user interfaces, comprising, by one or more computing devices:
receiving, on a first computing device, a first user input requesting selection of a first object and creation of an object category to associate with the first object in a listing in an electronic document of available objects;
receiving a first display rule associated with the object category, wherein the first display rule defines whether unselected objects in the object category can be displayed in the listing when the first object is selected;
receiving a second display rule associated with the first object, wherein the second display rule defines whether the first object can continue to be displayed in the listing when the first object is selected;
receiving, on a second computing device, a second user input requesting a display of objects in the listing;
rendering a first display of the listing on a user interface of the second computing device, the first display comprising at least the first object and one or more unselected objects;
receiving, on the second computing device, a third user input requesting selection of the first object from the first display;
analyzing the first object by:
determining that the first object was associated with the object category;
determining, by applying the first display rule associated with the object category, that at least one of the one or more unselected objects in the object category cannot be displayed when the first object is selected; and
applying the second display rule associated with the first object that defines whether the first object can continue to be displayed when the first object is selected; and
rendering a second display of the listing on the user interface of the second computing device, the second display comprising an updated display of objects in the listing according to the determined first display rule associated with the display of the one or more unselected objects and the determined second display rule associated with the display of the first object, wherein the at least one of the one or more unselected objects that cannot be displayed when the first object is selected has been removed from display in the second display of the listing.

2. The method of claim 1, wherein the first display rule instructs the one or more computing devices that at least two objects in the in the object category are desired, and wherein the second display comprises any object from the object category that has not been selected.

3. (canceled)

4. The method of claim 2, further comprising, by the one or more computing devices:
receiving, on the second computing device, a fourth user input requesting selection of a second object from the second display;
analyzing the second object; and
rendering a third display of the listing on the user interface of the second computing device.

5. The method of claim 4, wherein analyzing the second object comprises, by the one or more computing devices:
determining that the second object was associated with the object category;
applying the first display rule associated with the object category that defines whether one or more second unselected objects in the object category can be displayed when the second object is selected; and
applying a third display rule associated with the second object that defines whether the second object can continue to be displayed when the second object is selected.

6. The method of claim 5, wherein the third display comprises a second updated display of objects in the listing according to the first display rule associated with the display of the one or more second unselected objects and the third display rule associated with display of the second object.

7. The method of claim 4, wherein analyzing the second selected object comprises, by the one or more computing devices:
determining that the second object was placed in a second object category;
applying a fourth display rule associated with the second object category that defines whether one or more third unselected objects in the second object category can be displayed when the second object is selected; and
applying the third display rule associated with the second object that defines whether the second object can continue to be displayed when the second object is selected.

8. The method of claim 7, wherein the third display comprises a third updated display of objects in the listing according to the fourth display rule associated with the display of the one or more second unselected objects and the third display rule associated with display of the second object.

9. The method of claim 1, wherein the second display rule instructs the one or more computing devices that the first object can be selected two or more times, and wherein the second display comprises the selected object.

10. A computer program product, comprising:
a non-transitory computer-readable medium having computer-executable program instructions embodied thereon that when executed by computer cause the computer to optimize object presentations in graphical user interfaces, the computer-executable program instructions comprising instructions to:
receive, on a first computing device, a first user input requesting selection of a first object and creation of an object category to associate with the first object in a listing in an electronic document of available objects;
receive a first display rule associated with the object category, wherein the first display rule defines whether unselected objects in the object category can be displayed in the listing when the first object is selected;
receive a second display rule associated with the selected object, wherein the second display rule defines whether the first object can continue to be displayed in the listing when the first object is selected;
receive, on a second computing, a second user input device requesting a display of objects in the listing;
render a first display of the listing on a user interface of the second computing device, the first display comprising at least the first object and one or more unselected objects;
receive, on the second computing device, a third user input requesting selection of the first object from the first display;
analyze the first object by:
determine that the first object was associated with the object category;
determining, by applying the first display rule associated with the object category, that the at least one of the one or more unselected objects in the object category cannot be displayed when the first object is selected; and
applying the second display rule associated with the first object that defines whether the selected object can continue to be displayed when the first object is selected; and
render a second display of the listing on the user interface of the second computing device, the second display comprising an updated display of the objects in the listing according to the determined first display rule associated with the display of the one or more unselected object and the determined second display rule associated with the display of the first object, wherein the at least one of the one or more unselected objects that cannot be displayed when the first object is selected has been removed from display in the second display of the listing.

11. The computer program product of claim 10, wherein the first display rule instructs the one or more computing devices that at least two objects in the in the object category are desired, and wherein the second display comprises any object from the object category that has not been selected.

12. (canceled)

13. The computer program product of claim 10, further comprising instructions to: receive selection of a fourth user interface element on the second computing device
requesting selection of a second object from the second display;
analyze the second object by:
determining that the second object was associated with the object category;
applying the first display rule associated with the object category that defines whether one or more second unselected objects in the object category can be displayed when the second object is selected; and
applying the third display rule associated with the second object that defines whether the second object can continue to be displayed when the second object is selected; and
render a third display of the listing on the user interface of the second computing device, wherein the third display comprises a second updated display of objects in the listing according to the first display rule associated with the display of the one or more second unselected objects and the third display rule associated with display of the second object.

14. The computer program product of claim 10, further
comprising instructions to: receive selection of a fourth user interface element on the
second computing device requesting selection of a second object from the second display;
analyze the second object by:
determining that the second object was placed in a second object category;
applying a fourth display rule associated with the second object category that defines whether one or more third unselected objects in the second object category can be displayed when the second object is selected; and
applying a third display rule associated with the second object that defines whether the second object can continue to be displayed when the second object is selected; and
render a third display of the listing on the user interface of the second computing device, wherein the third display comprises the third updated display of the objects in the listing according to fourth display rule associated with the display of the one or more second unselected objects and the third display rule associated with display of the second object.

15. The computer program product of claim 10, wherein the second display rule instructs the one or more computing devices that the first object can be selected two or more times, and wherein the second display comprises the selected object.

16. A system to optimize object presentation on graphical user interfaces, comprising:
a storage device; and
a processor communicatively coupled to the storage device, wherein the processor executes application code instructions that are stored in the storage device to cause the system to:
receive, on a first computing device, a first user input requesting selection of a first object and creation of an object category to associate with the first object in a listing in an electronic document of available objects;
receive a first display rule associated with the object category, wherein the first display rule defines whether unselected objects in the object category can be displayed in the listing when the first object is selected;
receive a second display rule associated with the selected object, wherein the second display rule defines whether the first object can continue to be displayed in the listing when the first object is selected;
receive, on a second computing device, a second user input requesting a display of objects in the listing;
render a first display of the listing on a user interface of the second computing device, the first display comprising at least the first object and one or more unselected objects;
receive, on the second computing, a third user input device requesting selection of the first object from the first display;
analyze the first object by:
determine that the first object was associated with the object category;
determining, by applying the first display rule associated with the object category that at least one of the one or more unselected objects in the object category cannot be displayed when the first object is selected; and
applying the second display rule associated with the first object that defines whether the selected object can continue to be displayed when the first object is selected; and
render a second display of the listing on the user interface of the second computing device, the second display comprising an updated display of the objects in the listing according to the determined first display rule associated with the display of the one or more unselected object and the determined second display rule associated with the display of the first object, wherein the at least one of the one or more unselected objects that cannot be displayed when the first object is selected has been removed from display in the second display of the listing.

17. The system of claim 16, wherein the first display rule instructs the one or more computing devices that at least two objects in the in the object category are desired, and wherein the second display comprises any object from the object category that has not been selected.

18. The system of claim 16, wherein the first display rule instructs the one or more computing devices that only one object in the object category can be selected, and wherein rendering the second display comprises removing all remaining objects in the object category from display.

19. The system of claim 16, wherein the processor is further configured to execute application code instructions stored in the storage device to cause the system to:
receive selection of a fourth user interface element on the second computing device requesting selection of a second object from the second display;
analyze the second object by:
determining that the second object was associated with the object category;
applying the first display rule associated with the object category that defines whether one or more second unselected objects in the object category can be displayed when the second object is selected; and
applying the third display rule associated with the second object that defines whether the second object can continue to be displayed when the second object is selected; and
render a third display of the listing on the user interface of the second computing device, wherein the third display comprises a second updated display of objects in the listing according to the first display rule associated with the display of the one or more second unselected objects and the third display rule associated with display of the second object.

20. The system of claim 16, wherein the processor is further configured to execute application code instructions stored in the storage device to cause the system to:
receive selection of a fourth user interface element on the second computing device requesting selection of a second object from the second display;
analyze the second object by:
determining that the second object was placed in a second object category;
applying a fourth display rule associated with the second object category that defines whether one or more third unselected objects in the second object category can be displayed when the second object is selected; and
applying a third display rule associated with the second object that defines whether the second object can continue to be displayed when the second object is selected; and
render a third display of the listing on the user interface of the second computing device, wherein the third display comprises the third updated display of the objects in the listing according to fourth display rule associated with the display of the one or more second unselected objects and the third display rule associated with display of the second object.
